(19) United States
(12) Patent Application Publication
(10) Pub. No.: US 2018/0260780 A1
(43) Pub. Date: Sep. 13, 2018

(54) MOVABLE HUB DISTRIBUTION SYSTEM

(71) Applicant: Wheely's Café International AB, Varmdo (SE)

(72) Inventor: Tomas MAZETTI, Värmdö (SE)

(21) Appl. No.: 15/453,095

(22) Filed: Mar. 8, 2017

(51) Int. Cl. G06Q 10/08

(52) U.S. Cl. CPC G06Q 10/08355; H04W 84/042

(57) ABSTRACT

Directing transports with wireless communications to transport physical objects to locations. A method includes assigning (S1) a physical object with a unique identifier (P-ID) and a destination marker (P-DEST) identifying the location of the physical object, assigning (S2) the object to the transport, routing (S3) a first transport carrying the physical object, by determining (S3a) a route for the first transport based on the destination marker of the physical object and transmitting (S3b) the determined route to the first transport via wireless communications. Transports are routed (S4) to a geographical location where the first transport converges with a second transport to hand over the physical object directly to the second transport. The second transport is routed (S5) by determining (S5a) a route for the second transport based on the destination marker of the physical object and transmitting (S5b) the determined route to the second transport via wireless communications.

### TECHNICAL FIELD

The present disclosure relates to the field of transporting physical objects and to a method and a back end system for handling the transportation. In particular the present disclosure relates to directing at least two transports operating to transport at least one physical object to at least one location.

### BACKGROUND

Current freight systems are the remains from a world without knowledge. When an object, such as a package, is sent from one place in the world to another it travels alone towards that destination, even though, at many times, it will be grouped, or could easily be grouped with other parcels heading for the same destination.

Parcels that are sent a long way usually have several stops along the way, for example at hubs, sorting stations and warehouses. There they are often unloaded, re-sorted and then re-assigned to a transport. The routes of the parcels depend a lot on the stops along the way such that long detours are necessary.

### SUMMARY

This disclosure provides an improved method and a back end system for directing at least two transports operating to transport at least one physical object to at least one location. According to the disclosure, a method in a back end system handles effective routing of physical objects. Furthermore, a back end system for implementing the method is provided.

With the above description in mind, then, an aspect of the present disclosure is to provide a method and a back end system for improving transportation of physical objects, such as parcels, which seeks to mitigate, alleviate, or eliminate one or more of the above-identified deficiencies in the art and disadvantages singly or in any combination.

The present disclosure is defined by the appended independent claims. Various advantageous embodiments of the disclosure are set forth by the appended dependent claims as well as by the following description and the accompanying drawings.

According to some aspects of the disclosure, it provides for a method in a back end system for directing at least two transports operating to transport at least one physical object to at least one location. The at least two transports are equipped with wireless communication means for wireless communication, and wherein the at least two transports comprises a first and a second transport. The method comprises to assign a first physical object of the at least one physical objects with a unique identifier and a destination marker identifying the location of the first physical object, to assign the first physical object to the first transport, to route, via the wireless communication means, the first transport carrying the first physical object, by determining a route for the first transport based at least on the destination marker of the first physical object and transmitting the determined route to the first transport via the communications means. The method also comprises to route, via the wireless communication means, the first and the second transport to a geographical location where the first transport converges with the second transport to hand over the first physical object directly to the second transport, to route, via the communication means, the second transport carrying the first physical object by determining a route for the second transport based at least on the destination marker of the first physical object and transmitting the determined route to the second transport via the communications means. By routing the transports to a common geographical location to hand over the physical object, an efficient route for the object can be chosen. An efficient route will result in shorter delivery times, cheaper transports due to the decreased use of fuel of the transportation vehicles and less physical handling of the object.

According to some aspects, the method comprises determining the route and the transmitting the determined route are done repeatedly and thus the routing is updated repeatedly. In other words, the routing is continuously updated during transportation of the physical object. This ensures that the route can be changed if there is some kind of problem with the current route, such as a traffic accident or traffic jam. Thus, external parameters are continuously taken into consideration when updating the route. Another advantage is that the destination marker of the physical object can be updated during transportation; i.e. the target location of the physical object can change during transportation and the routing is then updated accordingly.

According to some aspects, the method comprises assigning the first and second transports with transport location markers which are automatically updated with current position information received from the transports. Thus, the back end system plans routes and locations to converge with other transports based on real time locations of the transports.

According to some aspects, determining a route is based at least on the transport location marker of the respective transport. In other words, the routing may be done continuously by using actual positions.

According to some aspects, the determining a route is based at least on a current traffic situation relevant for the respective transport. That is, the route is determined based on for example traffic accidents, traffic jams or road construction. Time and fuel can be saved by routing transports to avoid queues on the roads.

According to some aspects, the method comprises assigning the first physical object of the at least one physical objects with a position marker for current position of the physical object. This is to improve tracking of individual physical objects.

According to some aspects, the position marker inherits the value of the position marker of the transport it is currently assigned to. Thus, the position marker is updated each time the transport location marker is updated. The back end system will in this way be up to date about the location of each physical object it is routing.

According to some aspects, the method comprises assigning the first physical object of the at least one physical objects with a speed marker for current speed of the physical object. According to some aspects, the method comprises assigning the first transport with a speed marker for current speed of the first transport. If the back end system loses contact with the transport due to, for example, network issues, it is possible to estimate the current position using the route and the speed. The speed marker is also used to, according to some aspects, estimate arrival times to delivery locations or locations to hand over the objects.

According to some aspects, the speed marker inherits the value of the speed marker of the transport it is currently assigned to. In the regular case, the physical object, such as a parcel, does not have any means to determine its speed, or location on that matter, the speed marker of the physical object is inherited by the speed of the current transport.

According to some aspects, if the destination marker is updated during transportation, the routing is determined based on the new destination marker value.

According to some aspects of the disclosure, it provides for a back end system for directing at least two transports operating to transport at least one physical object to at least one location, wherein the at least two transports are equipped with wireless communication means for wireless. The at least two transports comprises a first and a second transport. The back end system comprises processing circuitry configured to cause the back end system to:
assign a first physical object of the at least one physical objects with a unique identifier and a destination marker identifying the location of the first physical object;
assign the first physical object to the first transport;
route, via the wireless communication means, the first transport carrying the first physical object, by:
   i. determining a route for the first transport based at least on the destination marker of the first physical object;
   ii. transmitting the determined route to the first transport via the communications means;
route, via the wireless communication means, the first and the second transport to a geographical location where the first transport converges with the second transport to hand over the first physical object directly to the second transport;
route, via the communication means, the second transport carrying the first physical object by:
   i. determining a route for the second transport based at least on the destination marker of the first physical object;
   ii. transmitting the determined route to the second transport via the communications means.

### BRIEF DESCRIPTION OF THE DRAWINGS

The present technique will be more readily understood through the study of the following detailed description of the aspects together with the accompanying drawings, of which:

FIGS. 1 and 2 is an explanation of the symbols used.

FIG. 3 illustrates the wireless communication between the computing cloud and different entities.

FIG. 4 illustrates transportation of objects according to prior art.

FIG. 5 illustrates restocking of a warehouse according to prior art.

FIG. 6-7 illustrate example routings of two transports.

FIG. 8 illustrates an example routing of a transport.

FIG. 9-14 illustrate example routings of two transports.

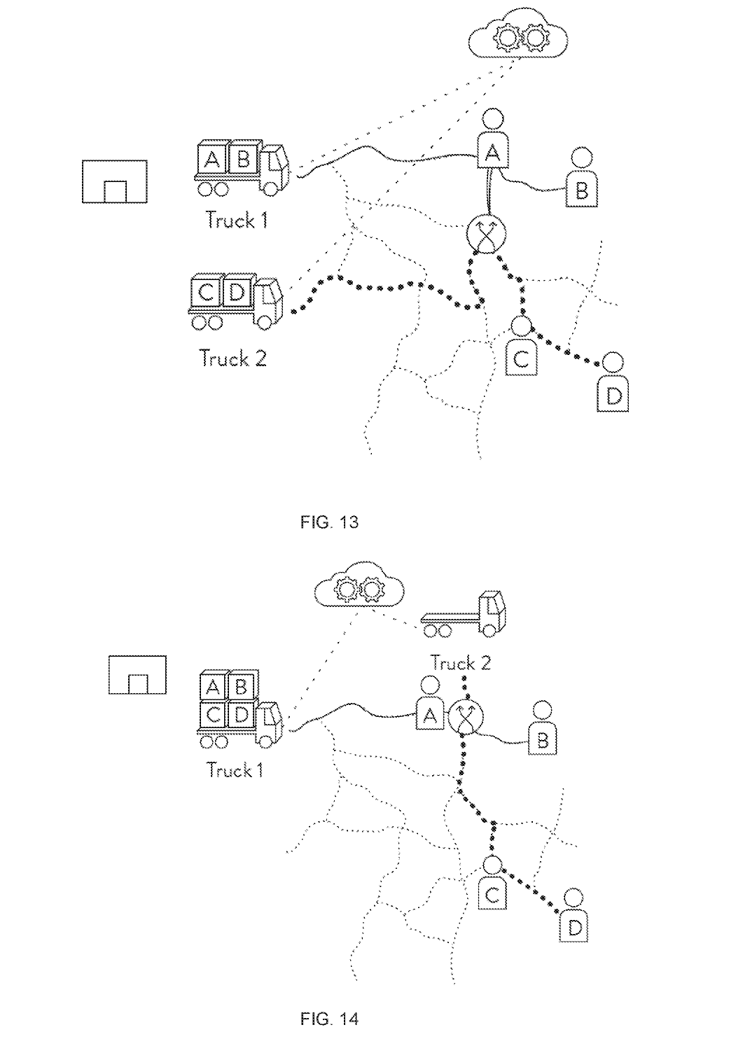

FIG. 15 illustrates example routings of four transports.

FIG. 16 illustrates example routing of two transports of different type.

FIG. 17-18 illustrate example routings of four transports.

FIG. 19 illustrates a block diagram of a back end system according to some aspects.

FIG. 20 illustrates a block diagram according to some aspects of the disclosure.

It should be added that the following description of the embodiments is for illustration purposes only and should not be interpreted as limiting the disclosure exclusively to these embodiments/aspects.

### DETAILED DESCRIPTION

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

Aspects of the disclosure are described with reference to the drawings, e.g., block diagrams and/or flowcharts. The numbers in the drawings refer to corresponding elements throughout.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved.

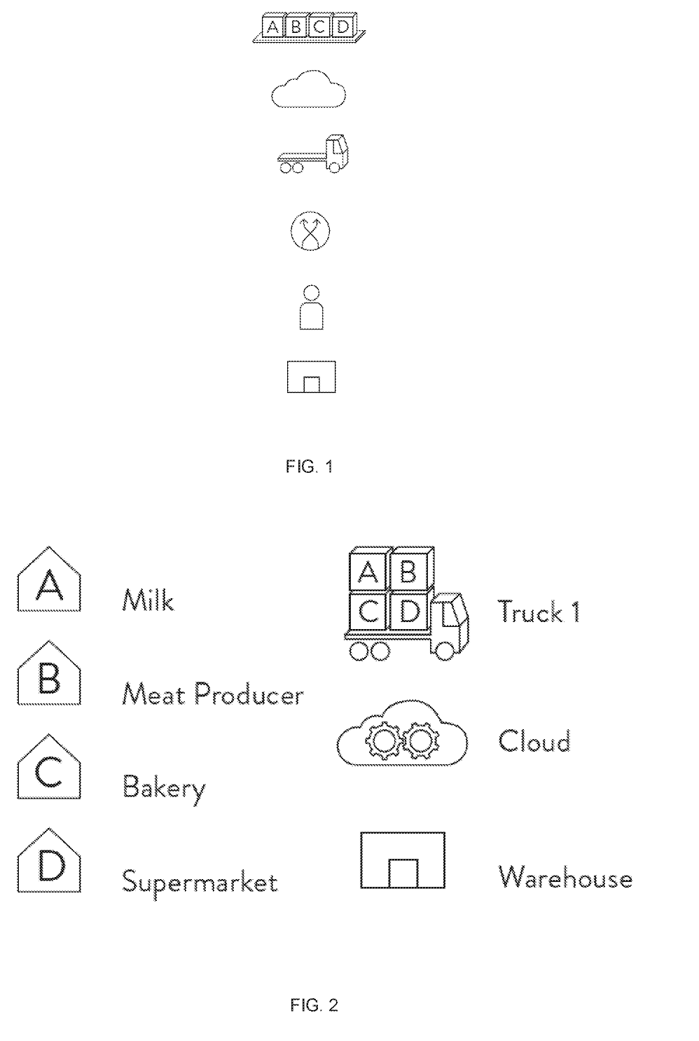

FIGS. 1 and 2 provides an explanation of the different illustrations used in the following figures. The square boxes with A, B, C and D in them are physical objects, or parcels, to be transported. The cloud illustrates the computing cloud, i.e. the cloud for internet based computing. The truck symbolizes a transport and can take many forms; such as a truck, a car, a ship, a boat, a bicycle, a motorbike, a person, a hot air balloon or an airplane. It should be noted that the transport can be an autonomous vehicle, i.e. a self-driving automated vehicle. In such a case, the below described process of handing over physical objects between transports is automated. The circle with two intersecting arrows illustrates a geographical location where two transports meet to hand over a physical object or objects. The person-shaped illustration illustrates customers. The rectangular shape with a door represents a warehouse. The house shapes illustrates delivery locations for physical objects with the corresponding letter, i.e. physical object A has delivery location house A.

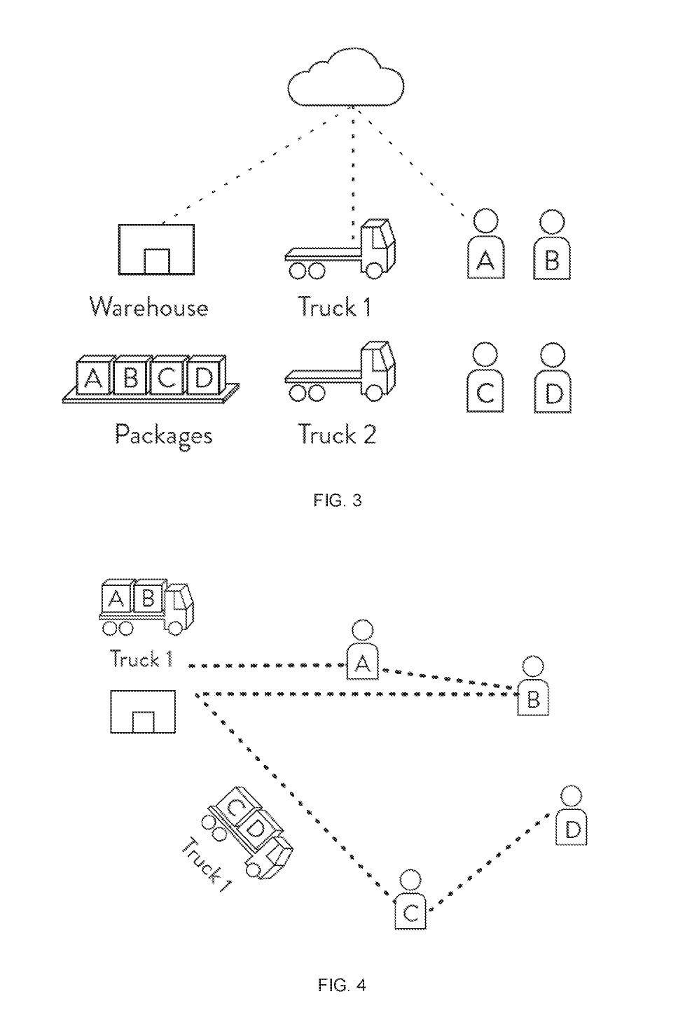

FIG. 3 illustrates that the cloud, here realized as a back end system, communicates wirelessly with the warehouse, the transports and clients.

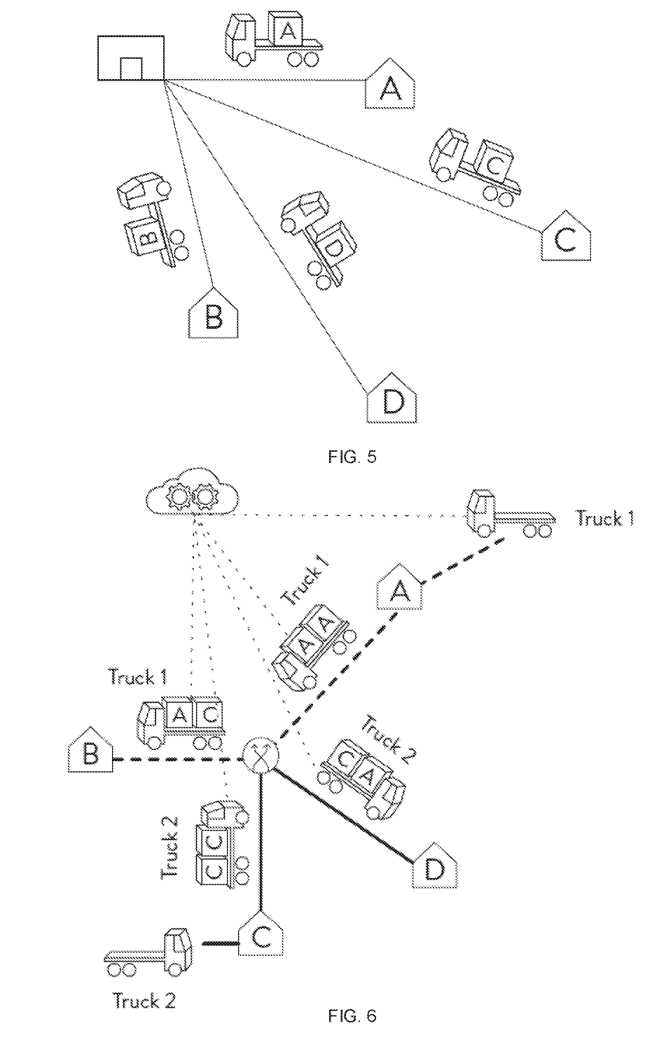

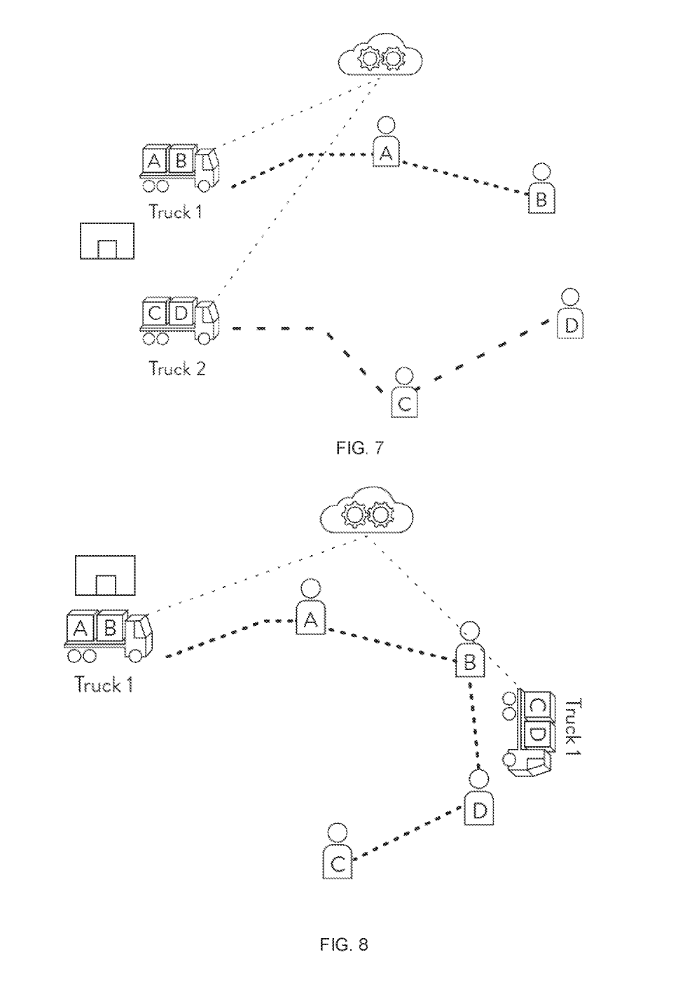

As discussed in the background, a traditional delivery system comprises to distribute objects from warehouses, or fixed hubs, using a transport. FIG. 4 illustrates a Truck 1 leaving a warehouse with physical objects A and B and delivering them to customers A and B. The Truck 1 then drives back to the warehouse, loads physical objects C and D and then drives to customers C and D. FIG. 5 illustrates restocking of the warehouse: four trucks transport the physical objects A, B, C and D to the warehouse.

The present disclosure presents a technique with a computer augmented system for distributing goods without static “warehouses”. Instead of today's system of moving goods to a warehouse, where individual parcels are re-routed towards a certain destination (or new static warehouse), unfixed geographical locations, or switch points, are used to move physical objects directly between transports.

An example of some aspects of the described technique is as follows. All the goods transported within a system are identified and given a globally unique P-ID, a marker indicating where it is heading P-DEST, a marker for what speed it is travelling toward that destination P-SPEED, a marker for where it is now, P-POS, and a marker for how much room it has for other P-ID's to be transported within it P-SPACE. It is important to point out that according to some aspects, any P-ID can also be the carrier, i.e. transport, of other P-IDs, since it can host other products inside itself; for instance, a drone containing five letters, inside in a truck inside a ferry. In this way the P-IDs become nested. The speed and destination of an underlying P-ID is defined by the speed and destination if the top P-ID, that is, the current speed and destination of the letter is defined by the speed and destination of the ferry.

With this data the system automatically finds the ideal points, called switch points, of moving goods from one vessel to another, or re-route vessels to such an ideal point in a huge net of carriers as well as automatically grouping products by destination. The meeting points for transferring goods may be anywhere, the goods may of any size and the carrier any carrier. A container changing ships at sea, packages transferred in air between zeppelins or two bikes swapping products in a street-corner. The system keeps track of the carriers using tracking systems such as GPS and road data and can reroute to avoid traffic or administrative hurdles.

A back end system collects all data and arranges the switch points on a global scale, from producers to end consumers.

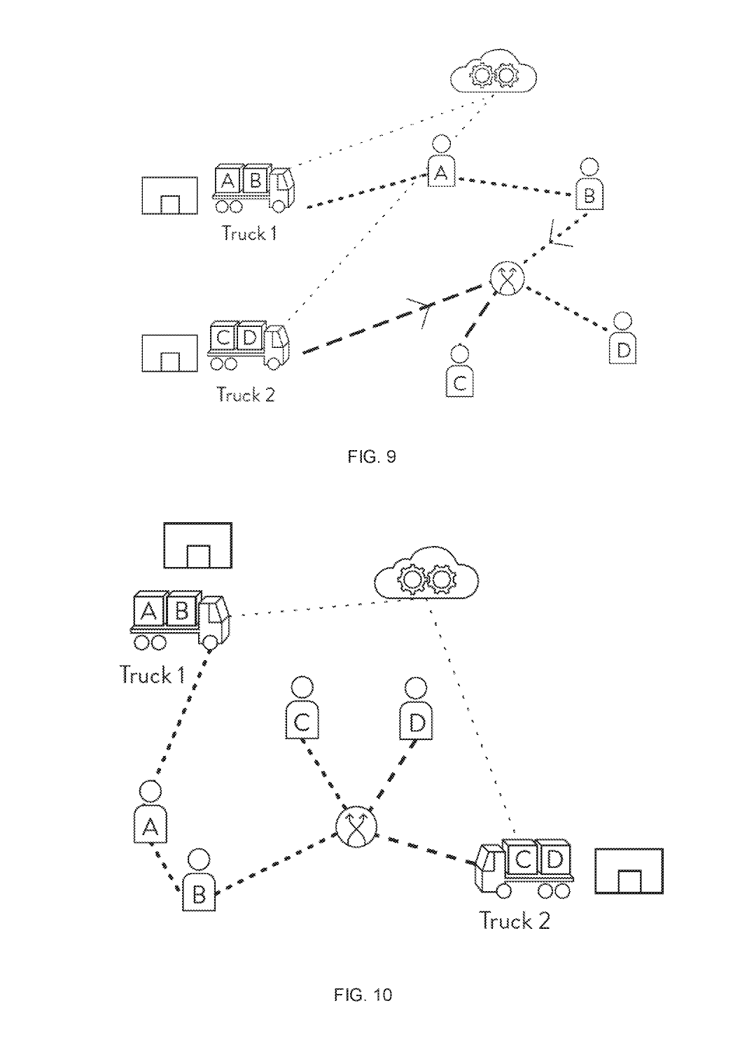

FIG. 6 illustrates an example of the above where one transport, Truck 1, collects two physical objects A at warehouse A and another transport, Truck 2, collects two physical objects C at warehouse C. However, warehouse B and D both need one physical object A and one physical object C. The back end system then uses the information it has regarding the transports and the physical objects to route the two transports to a location, or switch point, where they converge. Truck 1 hands over one physical object A to Truck 2 and Truck 2 hands over one physical object C to Truck 1. When they have made the hand over Truck 1 drives to warehouse B with physical objects A and C and Truck 2 drives to warehouse D with physical objects A and C. It should be noted that the trucks are used for illustrative purposes; the transports can be any type of transport.

The term “converge” in this disclosure is defined as to come together. I.e. that two transports converges means that they meet up at a geographical location.

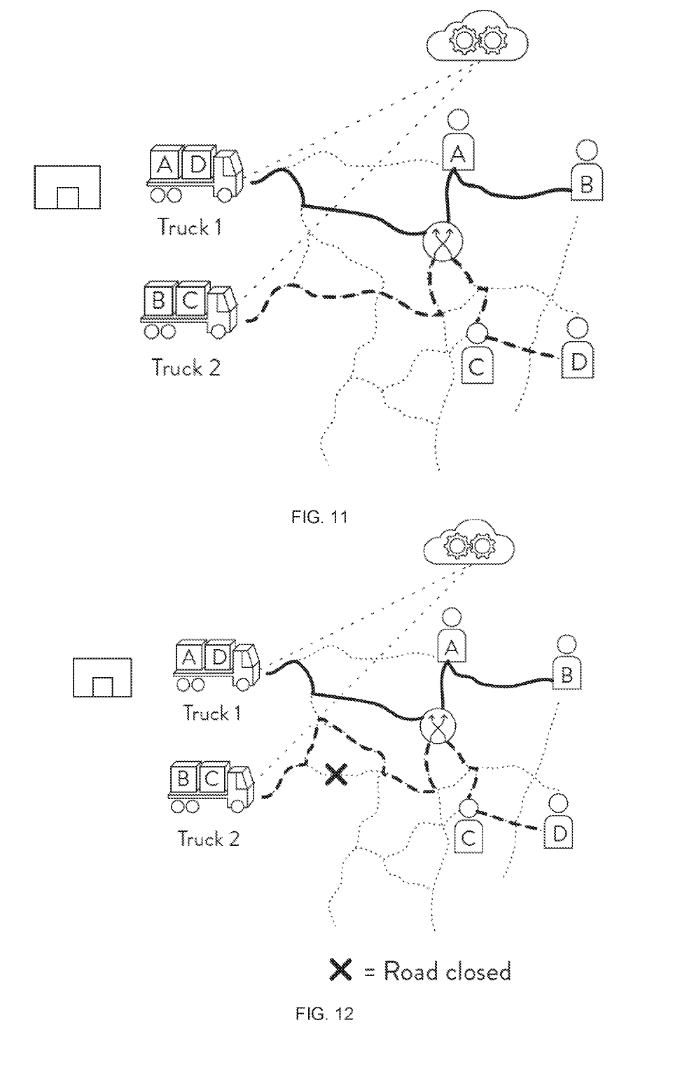

FIG. 7 illustrates an example case where the back end system has determined that it is most efficient for Truck 1 to deliver physical object A to customer A and B to customer B and for Truck 2 to deliver physical object C and D to customer C and D respectively. On the other hand, in the example in FIG. 8, the back end system has instructed Truck 1 to first deliver objects A and B, pick up objects D and C at customer B and deliver them directly to customers D and C. In this case customer B can be regarded as the first transport as described below.

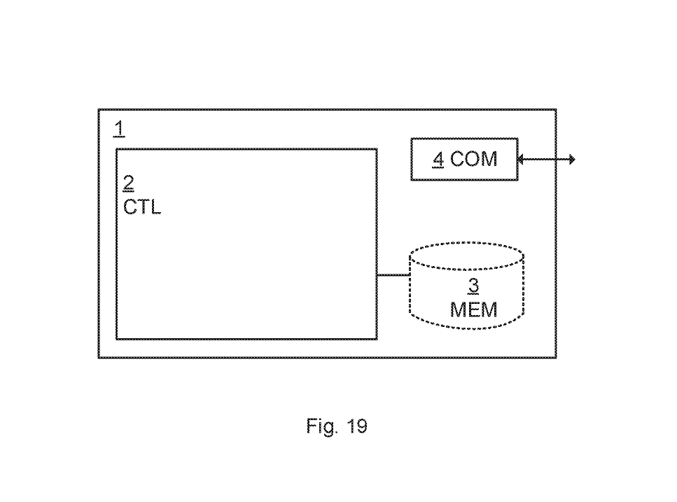

The method is performed in a back end system for directing at least two transports operating to transport at least one physical object to at least one location. Another word for transport is carrier. The transport is any type of carrier suitable for carrying a physical object from one geographical location to another. The transports can be either driven by a driver, an autonomous vehicle or a person. The at least two transports are equipped with wireless communication means for wireless communication. The two transports will wirelessly receive routing information from the back end system. Therefore, the transports are equipped with technology for receiving information wirelessly. Such technology is for example GSM, 3G or LTE. The wireless communication means may be any technology that enables the transport to receive and send information wirelessly from and to the back end system. The at least two transports comprises a first and a second transport. An example of the back end system 1 is illustrated in FIG. 19. The back end system 1 comprises processing circuitry 2 configured to cause the back end system to perform the method discussed below. The back end system comprises a memory 3 for storing information. The memory may be an internal memory, an external memory or an external cloud memory. It should be noted that the back end system may be realized in many forms, such as spread over a plurality of servers, therefore the back end system of FIG. 19 is for illustrative purposes only. In FIG. 19, the back end system also comprises communication circuitry 4 to enable communication with the transports and to receive information regarding destinations for physical objects.

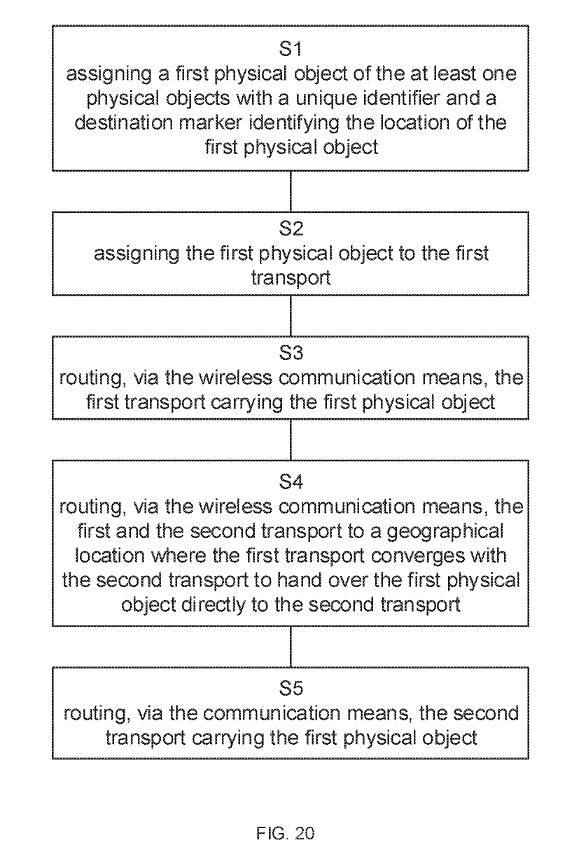

FIG. 20 illustrates a block diagram of the method. The boxes are not necessarily performed in the illustrated order.

The method comprises to assign S1 a first physical object of the at least one physical objects with a unique identifier P-ID and a destination marker P-DEST identifying the location of the first physical object. The unique identifier and the destination marker are according to some aspects a marker stored in a memory in the back end system. The back end system comprises at least one server. Since the back end system may be implemented in the cloud, it may be located in one or in a plurality of servers. According to some aspects, the unique identifier and/or the destination marker is also stored on a physical memory on the physical object. It is then possible to read the information directly from the memory on the physical object.

The first physical object is assigned S2 to the first transport. The first transport will physically pick up the physical object. The first transport carrying the first physical object, is routed S3, via the wireless communication means, by determining S3a a route for the first transport based at least on the destination marker of the first physical object and transmitting S3b the determined route to the first transport via the communications means. Routing here means the scheduling of the route of the transport. The scheduling is done by the above determining S3a and transmitting S3b. Note that the determined route is not necessarily to the location indicated in the destination marker, only based on the destination marker. The determined route may only be an initial direction to drive for the transport or a route to an initial location which is determined to be efficient for the physical object to go to initially.

The method also comprises to route S4, via the wireless communication means, the first and the second transport to a geographical location where the first transport converges with the second transport to hand over the first physical object directly to the second transport. The geographical location is an unfixed location where the transports can converge. Another word for the geographical location is switch point, or movable switch point, since the location is not based on the location of for example a warehouse or the like but is just a location where two, or more, transports converges to directly hand over one or more physical objects. Another word for the geographical location is a converging place, i.e. a place where the transports converges. In other words, the geographical location is a location where it is suitable for two or more transports to meet, both space wise and route wise for both transports. The first route S3 sent to the transport may already be to the geographical location for handing over the physical object but it can also be different. One example scenario is that the first transport is on its way towards the location to deliver the first physical object but the back end system then determines that it is more efficient if the second transport delivers the physical object; maybe because it is delivering another physical object to the same location or to a location nearby. The first and the second transports are then routed to a location where the first transport hands over the physical object to the second transport.

To hand over a physical object may be done in several ways depending on type of transport. An autonomous transport has an automated hand over system; for example using a robotic arm to move the physical object from one transport to the other, or for example to use a conveyor belt to transport the object from one transport to the other. There are many ways of realizing an automated system to handle physical objects in a transport, using for example automatic shelf systems, and robotic arms and/or conveyor belts. The handling of the physical objects within the transport can therefore be realized in many different ways. In the case where the transport that is driven by a driver, it may be the case that the driver hands over the physical objects to a driver of the other vehicle. According to some aspects, the first transport is an autonomous vehicle and the second transport is operated by a person or vice versa.

The method also comprises to route S5, via the communication means, the second transport carrying the first physical object by determining S5a a route for the second transport based at least on the destination marker of the first physical object and transmitting S5b the determined route to the second transport via the communications means. This routing is the same as the routing S3 for the first transport as explained above.

The above method describes where a transport carrying a physical object is routed to a geographical location where it converges with another transport to hand over the physical object to the other transport. The second transport may also be routed to the geographical location or the second transport is already at the geographical location when the first transport is routed there.

By routing the transports to a common geographical location to hand over the physical object, an efficient route for the object can be chosen. An efficient route will result in shorter delivery times, cheaper transports due to the decreased use of fuel of the transportation vehicles and less physical handling of the object.

FIG. 10 illustrates another example of the disclosure. In this case, the first transport, Truck 2, has two physical objects, C and D. The second transport, Truck 1, also carried two, A and B. Due to, for example traffic situations or geographical location of the customers the back end system determines that the most efficient way to deliver the four objects is that Truck 1 first delivers A and B and then converges with Truck 2 at the switch point and Truck 2 hands over object C to Truck 1. Truck 1 then delivers object C to customer C and Truck 2 delivers object D to customer D. FIG. 11 illustrates a similar example. Truck 1 and 2 converges at a geographical location, i.e. switch point, and Truck 1 hands over physical object D to Truck 2 and Truck 2 hands over physical object B to Truck 1. The transports then drive on to deliver the objects to the corresponding customers. In this case, both Trucks can be the first transport and the second transport since both trucks hand over an object to the other. In this figure, some lines representing roads are illustrated to get an idea regarding an example routing of the trucks.

The method comprises, according to some aspects, that the determining S3a, S5a the route and the transmitting S3b, S5b the determined route are done repeatedly and thus the routing S3, S5 is updated repeatedly. In other words, the routing is continuously updated during transportation of the physical object. In other words, the route is updated at least one time by determining and sending a new route to the transport. This ensures that the route can be changed if there is some kind of problem with the current route, such as a traffic accident or traffic jam. Thus, external parameters are continuously taken into consideration when updating the route. Current position of other transports may also be a reason to update the route of a transport. It may be that the current route and a new route are equal in time and fuel consumption but the new route positions the transport closer to another transport. Then it may be beneficial to update to the new route in case there is a need for the two transports to converge. Another advantage is that the destination marker of the physical object can be updated during transportation; i.e. the target location of the physical object can change during transportation and the routing is then updated accordingly.

FIG. 12 illustrates an example where the route of Truck 2 is changed due to a closed road. This re-routing may be done by updating the route sent to the truck or the longer route was planned from the start because the back end system was aware of the closed road before the truck was dispatched. Other that the detour of Truck 2, the figure is the same as FIG. 11. Another example is if the destination marker P-DEST is updated during transport. Such may be the case if for example an order for the object is changed or a new demand is recognized. An example situation: A company wants to transfer 1000 computers to a store in the US and 1000 to a store in Europe. While in transit, the US stores sells its entire inventory, while the European does not sell any. While still in route, the goods can be re-transited to the US stores. An example of this is illustrated in FIG. 13; Truck 1 is on its way to customer A with physical object A when the destination of physical object A is changed to customer C. Truck 1 and 2 are then routed to converge at a geographical location to hand over object A to Truck 2 for Truck 2 to deliver it to customer C together with physical object C.

Another example is illustrated in FIG. 14, Truck 1 is on its way to deliver 4 objects A, B, C and D to four respective locations. Suddenly Truck 2 is available. The back end system then reroutes Truck 1 and 2 to converge. In this example case it is decided that the most efficient geographical location to converge is after Truck 1 has dropped of object A at customer A. Truck 2 then gets physical objects C and D from Truck 1 and delivers them at the respective location while Truck 1 delivers object B.

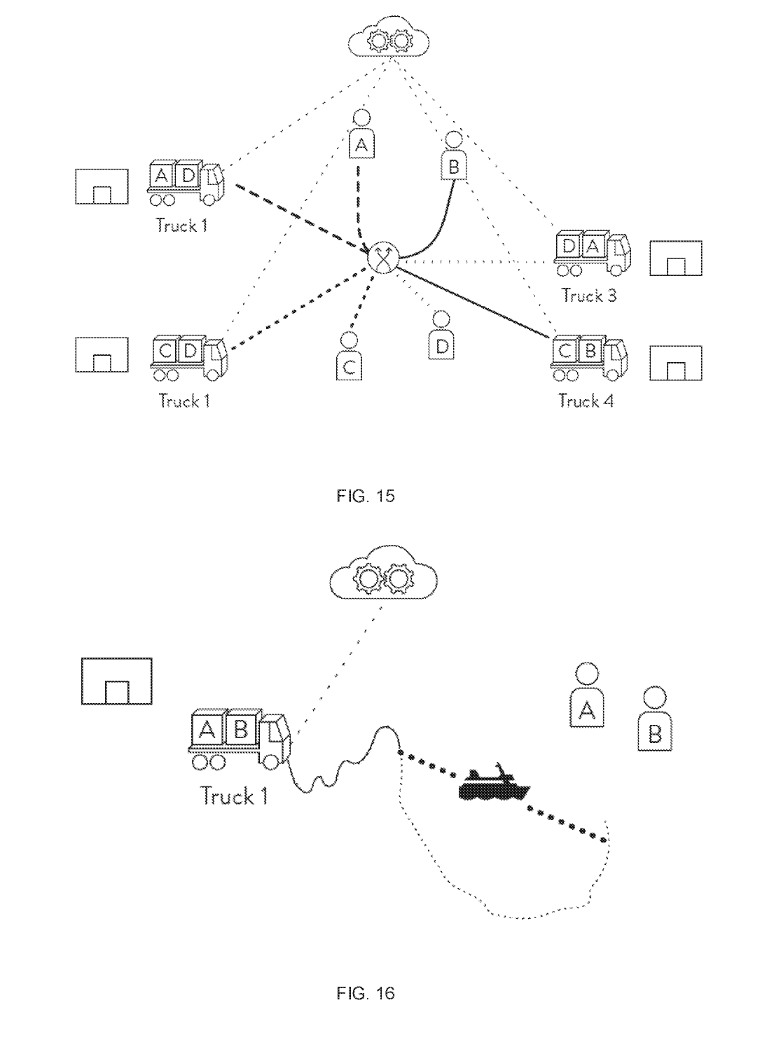

There might be the case where there are several physical objects of the same type or at least that are to be delivered at the same location. In FIG. 15, Truck 1 and 3 both carries an object A destined for customer A. Truck 1, 2 and 3 all carry objects D, Truck 2 and 4 carries C, Truck 4 carries B. The four trucks are all routed to the same geographical location to perform multiple hand overs. Truck 3 hands over object A to Truck 1 while Truck 1 and 2 hands over object D to Truck 3. Truck 4 hands over object C to Truck 2. After the switch, all trucks just have one delivery location to go to; Truck 1 to customer A, Truck 2 to C, Truck 3 to D and Truck 4 to B. In this case all transport can be regarded as the first transport according to above, but all trucks but Truck 4 can be regarded as the second transport since Truck 4 does not receive an object at the geographical location.

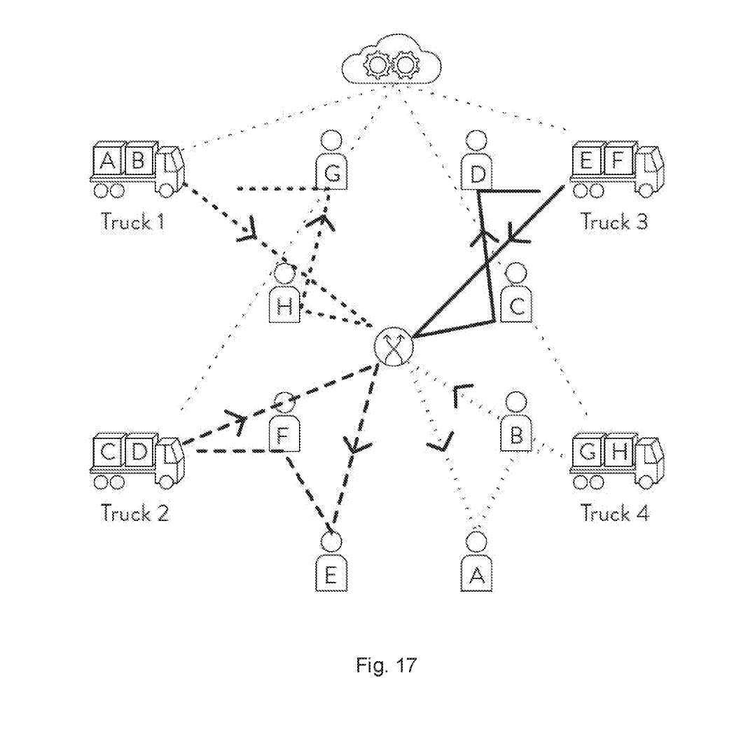

FIG. 16 illustrates an example where the first transport is a truck, Truck 1, and the second transport is a ship. This is to illustrate that the transports can be any kind of transport capable of carrying a physical object over a distance.

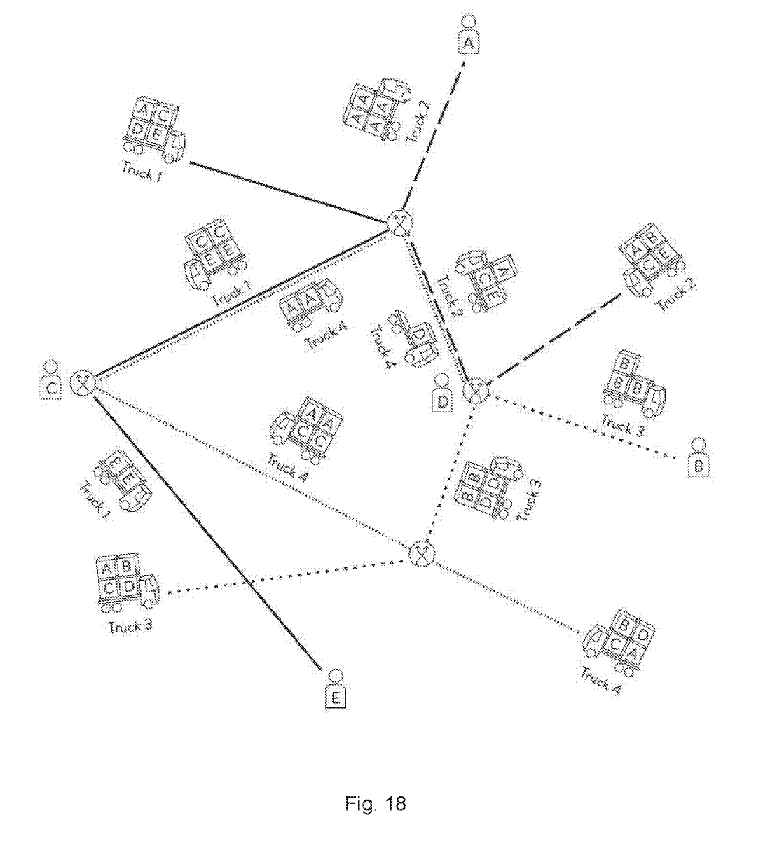

FIG. 17 illustrates an example of where four transports are routed to a geographical location to hand over packages. Instead of Truck 1-4 driving to their original destinations they switch packages at the indicated meeting point, i.e. the geographical location, allowing them to switch long distance destinations for more convenient destinations within reach on their way back home. For example: Truck 1 and Truck 4 is going to deliver packages close to the other Trucks Origin. By switching packaged halfway, Truck A delivers package G and H instead of A and B and Truck 4 delivers Package A and B, instead of H and G. The same goes for Truck 2 and 3, they switch physical objects at the geographical location to deliver them on their way back.

FIG. 18 is an illustration of an example with four trucks, physical objects with four destinations and four geographical locations to hand over objects. The System calculates several meeting points for optimizing delivery. The more trucks and destinations in the system the more efficient the system becomes, if a package is re-routed the entire system is re-calculated instantly and accordingly. In this example Truck 1 first converges with Truck 2 and 4 to hand over physical object A to Truck 2 and D to truck 4 and to receive physical object C and E from truck 2. Then Truck 1 delivers physical objects C to customer C and then physical objects E to customer E. Truck 2 starts with meeting Truck 3 at customer D to hand over physical objects B. Truck 2 then continues to it meeting point with Truck 1 and 4 where it receives objects A. Thereafter Truck 2 loads only physical objects of type A which Truck 2 delivers to customer A. Truck 3 first converges with Truck 4 to hand over A and C and receive B and D. It then continues to customer D where it delivers physical objects D and receives physical objects B from Truck 2. Truck 3 then delivers physical objects B to customer B. Truck 4 first converges with Truck 3 according to above, delivers objects C to customer C and then converges with Truck 1 and 2 to hand over objects A and to receive D. Truck 4 then delivers physical object D to customer D. The distance for delivering the physical objects without geographical meeting points and hand over between trucks, the distance each truck travels is as follows (arbitrary units):

Truck 1: 223

Truck 2: 258

Truck 3: 206

Truck 4: 253

But with the hand overs at geographical locations, the traveled distance for each truck can be reduced to:

Truck 1: 150

Truck 2: 90

Truck 3: 106

Truck 4: 178

Thus, the travel distance for the trucks using hand over is 524 compared to 940 if the trucks deliver the physical objects by themselves. Thus, 45% in travel distance is saved by using the method.

It should be noted that the technique according to the disclosure is applicable to a system with one physical object and two transports as well as to a system with any number of physical objects and any number of transports more than 1. The more transports and physical objects that are handled with the described method, the more efficient it can be. The system is applicable on a global scale.

To keep track of the transports and the physical objects it is carrying in real time, the method comprises, according to some aspects, assigning S1a the first and second transports with transport location markers C-POS which are automatically updated with current position information received from the transports. Thus, the back end system plans routes and locations to converge with other transports based on real time locations of the transports. Thus, according to some aspects, determining S3a, S5a a route is based at least on the transport location marker C-POS of the respective transport. In other words, the routing may be done continuously by using actual positions.

The transports are, in this case, equipped with positioning technology. The positioning technology is for example a GPS. It should be noted that the wireless communication technology and/or the positioning technology in a transport can be realized by having a smart phone in the transport.

The determining S3a, S5a a route is, according to some aspects, based at least on a current traffic situation relevant for the respective transport. That is, the route is determined based on for example traffic accidents, traffic jams or road construction. If the current route of the transport is suddenly blocked, for example by a traffic accident. The back end system re-routes the transport to avoid the block. Time and fuel can be saved by routing transports to avoid queues on the roads. The routing may also be determined based on routing history of the transports. For example, route history of the transports may reveal a pattern that some roads are prone to traffic jams at certain times of the day. The routing may then be based on that history to avoid the traffic jams at those times.

The method comprises, according to some aspects, to assign S1b the first physical object of the at least one physical objects with a position marker P-POS for current position of the physical object. This is to improve tracking of individual physical objects. According to some aspects, the position marker P-POS inherits the value of the position marker C-POS of the transport it is currently assigned S2 to. Thus, the position marker is updated each time the transport location marker is updated. The back end system will in this way be up to date about the location of each physical object it is routing.

The method comprises, according to some aspects, assigning S1c the first physical object of the at least one physical objects with a speed marker P-SPEED for current speed of the physical object. Also, according to some aspects, the method comprises assigning S1d the first transport with a speed marker C-SPEED for current speed of the first transport. If the back end system loses contact with the transport due to, for example, network issues, it is possible to estimate the current position using the route and the speed. The speed marker is also used to, according to some aspects, estimate arrival times to delivery locations or locations to hand over the objects. Current speed of a transport is determined for example by a speedometer or by a positioning technology that determines the speed based on the time it takes to change location between two points. According to some aspects, the speed marker P-SPEED inherits the value of the speed marker C-SPEED of the transport it is currently assigned S2 to. In the regular case, the physical object, such as a parcel, does not have any means to determine its speed, or location on that matter, so the speed marker of the physical object is inherited by the speed of the current transport. But it may also be that the physical object is equipped with technology to for example determine position and/or speed.

If the destination marker P-DEST is updated during transportation, the routing is determined S3a, S5a based on the new destination marker value. In other words, no destination needs to be fixed and can be updated during transport. This allows for a flexibility of the system.

As previously discussed, a back end system 1 is provided for performing the above method. According to some aspects of the disclosure, it provides for a back end system 1 for directing at least two transports operating to transport at least one physical object to at least one location, wherein the at least two transports are equipped with wireless communication means for wireless. The at least two transports comprises a first and a second transport. The back end system comprises processing circuitry 2 configured to cause the back end system to:
assign S1 a first physical object of the at least one physical objects with a unique identifier P-ID and a destination marker P-DEST identifying the location of the first physical object;
assign S2 the first physical object to the first transport;
route S3, via the wireless communication means, the first transport carrying the first physical object, by:
   i. determine S3a a route for the first transport based at least on the destination marker of the first physical object;
   ii. transmit S3b the determined route to the first transport via the communications means;
route S4, via the wireless communication means, the first and the second transport to a geographical location where the first transport converges with the second transport to hand over the first physical object directly to the second transport;
route S5, via the communication means, the second transport carrying the first physical object by:
   i. determining S5a a route for the second transport based at least on the destination marker of the first physical object;
   ii. transmitting S5b the determined route to the second transport via the communications means.

All of these functions have been previously described in detail when discussing the method.

To keep track of a transport, or in other words, a carrier, a carrier ID, C-ID may be assigned to each transport. A transport with a C-ID can in itself also be a product with a P-ID. In other words, a physical object, or a product can be a transport carrying other physical objects. Any C-ID may serve as the final address for a physical object. This is valuable in places where people do not have fixed addresses (large part of the developing world), or simply want to pick up their things somewhere else than home.

The numbers of transports participating in the total system can be multiplied by letting private individuals, who is accredited and would like to participate, like Uber or Svenska Posten, be part of the system.

An advantage with the above described method is that all physical objects, both specially ordered ones, and stocks to stores are to be part of the same system; one could call it a protocol for transporting physical goods.

The techniques according to this disclosure may for example be used when refilling stocks at café s within a city or suburbs. The techniques may be used in any case when a physical object is to be transported from one location to another and where the system owner has access to at least two transports.

An example of use is as follows: A shipment of coffee is sent from a farm in Rwanda, half of it going to 30 clients in the US, 30 to clients in Europe and 10 to Peru. The coffee is put into 200 crates, each with an individual P-ID that in its turn are put in a container, with another P-ID.

The back end system examines possible routes and finds a meeting place in Uganda, where one ships is going to Greece and another to Washington. The goods for US and Peru are put onto one ship, and the good for Europe in another. At the same time, a box of dresses headed for a store in Dûsseldorf is stacked within the box going to Europe.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed. It should further be noted that any reference signs do not limit the scope of the claims, that the example embodiments may be implemented at least in part by means of both hardware and software.

In the drawings and specification, there have been disclosed exemplary aspects of the disclosure. However, many variations and modifications can be made to these aspects without substantially departing from the principles of the present disclosure. Accordingly, although specific terms are employed, they are used in a generic and descriptive sense only and not for purposes of limitation. The scope of the disclosure being defined by the following claims.

1. A method in a backend system for directing at least two transports operating to transport at least one physical object to at least one location, wherein the at least two transports are equipped with wireless communication means for wireless communication, and wherein the at least two transports comprises a first and a second transport, wherein the method comprises:
assigning a first physical object of the at least one physical objects with a unique identifier and a destination marker identifying the location of the first physical object;
assigning the first physical object to the first transport;
routing, via the wireless communication means, the first transport carrying the first physical object, by:
i. determining a route for the first transport based at least on the destination marker of the first physical object;
ii. transmitting the determined route to the first transport via the communications means;
routing, via the wireless communication means, the first and the second transport to a geographical location where the first transport converges with the second transport to hand over the first physical object directly to the second transport;
routing, via the communication means, the second transport carrying the first physical object by:
i. determining a route for the second transport based at least on the destination marker of the first physical object;
ii. transmitting the determined route to the second transport via the communications means.

2. The method according to claim 1, wherein the determining the route and the transmitting the determined route are done repeatedly and thus the routing is updated repeatedly.

3. The method according to claim 1, comprising:
assigning the first and second transports with transport location markers which are automatically updated with current position information received from the transports.

4. The method according to claim 3, wherein the determining a route is based at least on the transport location marker of the respective transport.

5. The method according to claim 3, wherein the determining a route is based at least on a current traffic situation relevant for the respective transport.

6. The method according to claim 3, comprising:
assigning the first physical object of the at least one physical objects with a position marker for current position of the physical object.

7. The method according to claim 6, wherein the position marker inherits the value of the position marker of the transport it is currently assigned to.

8. The method according to claim 1, comprising:
assigning the first physical object of the at least one physical objects with a speed marker for current speed of the physical object.

9. The method according to claim 8, comprising:
assigning the first transport with a speed marker for current speed of the first transport.

10. The method according to claim 9, wherein the speed marker inherits the value of the speed marker of the transport it is currently assigned to.

11. The method according to claim 1, wherein if the destination marker is updated during transportation, the routing is determined based on the new destination marker value.

12. A back end system for directing at least two transports operating to transport at least one physical object to at least one location, wherein the at least two transports are equipped with wireless communication means for wireless, and wherein the at least two transports comprises a first and a second transport, wherein the back end system comprises processing circuitry configured to cause the back end system to:
assign a first physical object of the at least one physical objects with a unique identifier and a destination marker identifying the location of the first physical object;
assign the first physical object to the first transport;
route, via the wireless communication means, the first transport carrying the first physical object, by:
i. determining a route for the first transport based at least on the destination marker of the first physical object;
ii. transmitting the determined route to the first transport via the communications means;
route, via the wireless communication means, the first and the second transport to a geographical location where the first transport converges with the second transport to hand over the first physical object directly to the second transport;
route, via the communication means, the second transport carrying the first physical object by:
i. determining a route for the second transport based at least on the destination marker of the first physical object;
ii. transmitting the determined route to the second transport via the communications means.
